(19) United States
(12) Patent Application Publication
(10) Pub. No.: US 2016/0098222 A1
(43) Pub. Date: Apr. 7, 2016

(54) CONTROLLING DEVICE, CONTROLLED DEVICE, AND OPERATING METHOD

(71) Applicant: Nuvoton Technology Corporation, Hsinchu (TW)

(72) Inventors: Hsi-Jung TSAI, Hsinchu (TW); Chia-Ching LU, Hsinchu (TW); Yueh-Yao NAIN, Hsinchu (TW); Yi-Ching LEE, Hsinchu (TW); Chang-Chung LIU, Hsinchu (TW)

(21) Appl. No.: 14/818,315

(22) Filed: Aug. 5, 2015

(30) Foreign Application Priority Data
Oct. 7, 2014 (TW) 103134906

(51) Int. Cl. G06F 3/06; G06F 13/42

(52) U.S. Cl. CPC G06F 3/0625; G06F 13/4282; G06F 3/0688; G06F 3/0659; G06F 3/061

(57) ABSTRACT

A controlled device includes a non-volatile memory, a power pin, and a controller. The controller is configured for performing, through a negotiation module, a power negotiation operation with a controlling device via the power pin; receiving a programming declaration from the controlling device via the power pin; disabling the negotiation module according to the programming declaration; receiving a programming data from the controlling device via the power pin after the negotiation module is disabled; and writing the programming data into the non-volatile memory. In other embodiment, the controlled device can further includes at least one configuration channel pin for receiving the programming declaration therethrough.

### RELATED APPLICATIONS

This application claims priority to Taiwanese Application Serial Number 103134906, filed Oct. 7, 2014, which is herein incorporated by reference.

### BACKGROUND

1. Field of Invention

The present disclosure relates to electronic devices. More particularly, the present disclosure relates to a controlling device, a controlled device, and an operating method.

2. Description of Related Art

With advances in electronic technology, universal serial bus (USB) is widely used in various kinds of electronic devices, such as personal computers and mobile phones.

A typical USB device includes a power pin (e.g., VBUS) and data pins (e.g., D+, D−) respectively configured for transmitting power and data between USB devices. A controlling device can provide a control signal to a controlled device via the data pin, so as to control the controlled device to perform a corresponding operation.

### SUMMARY

One aspect of the present disclosure is related to a controlled device. In accordance with one embodiment of the present disclosure, the controlled device includes a non-volatile memory, a power pin, and a controller. The controller is configured for performing, by using a negotiation module, a power negotiation operation with a controlling device via the power pin; receiving a programming declaration from the controlling device via the power pin; disabling the negotiation module according to the programming declaration; receiving a programming data from the controlling device via the power pin after the negotiation module is disabled; and writing the programming data into the non-volatile memory.

Another aspect of the present disclosure is related to an operating method. In accordance with one embodiment of the present disclosure, the operating method is applied to a controlled device. The operating method includes steps of: performing, by using a negotiation module of the controlled device, a power negotiation operation with a controlling device via the power pin of the controlled device; receiving a programming declaration from the controlling device via the power pin; disabling the negotiation module according to the programming declaration; receiving a programming data from the controlling device via the power pin after the negotiation module is disabled; and writing the programming data into a non-volatile memory of the controlled device.

Another aspect of the present disclosure is related to a controlling device. In accordance with one embodiment of the present disclosure, the controlling device includes a power pin and a controller. The controller is configured for performing, by using a negotiation module, a power negotiation operation with a controlled device via the power pin; transmitting a programming declaration to the controlled device via the power pin; receiving an allowance of programming from the controlled device via the power pin after transmitting the programming declaration to the controlled device; disabling the negotiation module according to the allowance of programming; and transmitting a programming data to the controlled device via the power pin after the negotiation module is disabled, to control the controlled device to write the programming data into a non-volatile memory thereof.

Another aspect of the present disclosure is related to a controlled device. In accordance with one embodiment of the present disclosure, the controlled device includes a non-volatile memory, a configuration channel pin, and a controller. The controller is configured for receiving a programming declaration from a controlling device via the configuration channel pin, receiving a programming data from the controlling device via the configuration channel pin, and writing the programming data to the non-volatile memory.

Through utilizing one embodiment described above, the programming data can be written into the non-volatile memory of the controlled device without using data pins. In such a manner, the number of pins of the controlled device and the cost of manufacturing the same can be reduced, and the number of different types of applications for the controlled device can be increased.

### BRIEF DESCRIPTION OF THE DRAWINGS

FIG. 1 is a schematic diagram of a controlling system according to one embodiment of the present disclosure.

FIG. 2A is a flow chart of an operating method of a controlling device according to one embodiment of the present disclosure.

FIG. 2B is a flow chart of an operating method of a controlled device according to one embodiment of the present disclosure.

FIG. 3 illustrates a vender-defined message (VDM) according to one embodiment of the present disclosure.

FIG. 4 illustrates details of the VDM according to one embodiment of the present disclosure.

FIG. 5A is a flow chart of an operating method of a controlling device according to one embodiment of the present disclosure.

FIG. 5B is a flow chart of an operating method of a controlled device according to one embodiment of the present disclosure.

FIG. 6 is a schematic diagram of a controlling system according to one embodiment of the present disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “electrically connected” to another element, it can be directly connected or coupled to the other element, or intervening elements may be present. In contrast, when an element is referred to as being “directly connected” to another element, there are no intervening elements present. Moreover, “connect” or “electrically connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

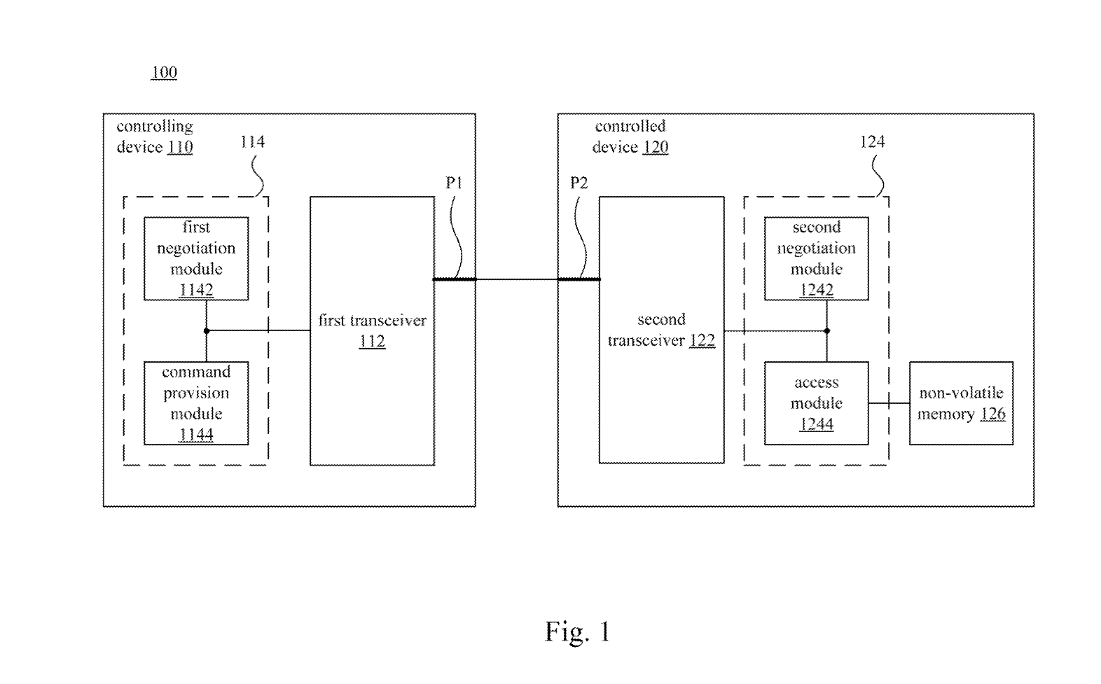

FIG. 1 is a schematic diagram of a controlling system 100 according to one embodiment of the present disclosure. The controlling system 100 includes a controlling device 110 and a controlled device 120. In this embodiment, the controlling device 110 and the controlled device 120 are electrically connected to each other. In one embodiment, the controlling device 110 can be, for example, a desktop computer, and the controlled device 120 can be, for example, a smartphone, but the present disclosure is not limited in this regard. In one embodiment, the controlling device 110 can control the controlled device 120 to access a non-volatile memory thereof (e.g., control the controlled device 120 to update the firmware thereof). However, the present disclosure is not limited to such an embodiment. Other electronic devices and operations are within the contemplated scope of the present disclosure.

In this embodiment, the controlling device 110 includes a first power pin P1, a first transceiver 112, and a first controller 114. The first transceiver 112 is electrically and separately connected to the first controller 114 and the first power pin P1. In one embodiment, the first controller 114 includes a first negotiation module 1142 and a command provision module 1144. The first negotiation module 1142, the command provision module 1144, and the first transceiver 112 are electrically connected to each other.

In this embodiment, the controlled device 120 includes a second power pin P2, a second transceiver 122, a second controller 124, and a non-volatile memory 126. The second transceiver 122 is electrically and separately connected to the second controller 124 and the second power pin P2. The second power pin P2 is electrically connected to the first power pin P1. The second controller 124 is electrically connected to the non-volatile memory 126. In one embodiment, the second controller 124 includes a second negotiation module 1242 and an access module 1244. The second negotiation module 1242 is electrically connected to the second transceiver 122 and the access module 1244. The access module 1244 is electrically connected to the non-volatile memory 126.

In one embodiment, the access module 1244 can be electrically connected to the non-volatile memory 126 directly or indirectly by using, for example, a serial peripheral interface bus (SPI), an inter-integrated circuit (I²C), or other suitable interface.

In one embodiment, the first transceiver 112 and the second transceiver 122 can be realized by, for example, circuits (e.g., integrated circuits). The first controller 114 and the second controller 124 can be realized by, for example, central processors, microprocessors, or other suitable calculating devices. In one embodiment, the power pins P1, P2 can be realized by, for example, a power pin “Vbus” used in a universal serial bus (USB) cable or connector.

In one embodiment, the first transceiver 112, the second transceiver 112, the first negotiation module 1142, and the command provision module 1144 can be implemented on a single chip or several individual chips. Similarly, the second transceiver 122, the second negotiation module 1242, and the access module 1244 can be implemented on a single chip or several individual chips, but the present disclosure is not limited in this regard.

In addition, in one embodiment, the functions of the first controller 114, the second controller 124, the first negotiation module 1142, the command provision module 1144, the second negotiation module 1242, and the access module 1244 can be realized by a processor implementing a computer program stored in a computer readable storage medium. The computer readable storage medium can be realized by, for example, a ROM (read-only memory), a flash memory, a floppy disc, a hard disc, an optical disc, a flash disc, a tape, a database accessible from a network, or another suitable storage component.

In this embodiment, the first negotiation module 1142 and the second negotiation module 1242 are respectively configured for controlling the first transceiver 112 and the second transceiver 122, so as to perform a power negotiation operation via the power pins P1 and P2, and determine a power supply direction between the controlling device 110 and the controlled device 120 (e.g., to determine whether the power is supplied to the controlled device 120 from the controlling device 110, or to the controlling device 110 from the controlled device 120), and a power supply specification (e.g., the voltage value and current value supplied to the consumer by the provider). After the power negotiation operation, the provider (one of the controlling device 110 and the controlled device 120) can supply the power to the consumer (the other of the controlling device 110 and the controlled device 120) via the power pins P1 and P2, to allow the consumer to operate based on the received power.

In this embodiment, the command provision module 1144 can be configured for controlling the first transceiver 112 to provide a controlling command to the controlled device 120 via the power pins P1 and P2 for performing related operations. The access module 1244 can be configured for receiving the controlling command via the second receiver 122 and performing a corresponding operation according to the controlling command (e.g., reading, programming, or erasing the non-volatile memory 126).

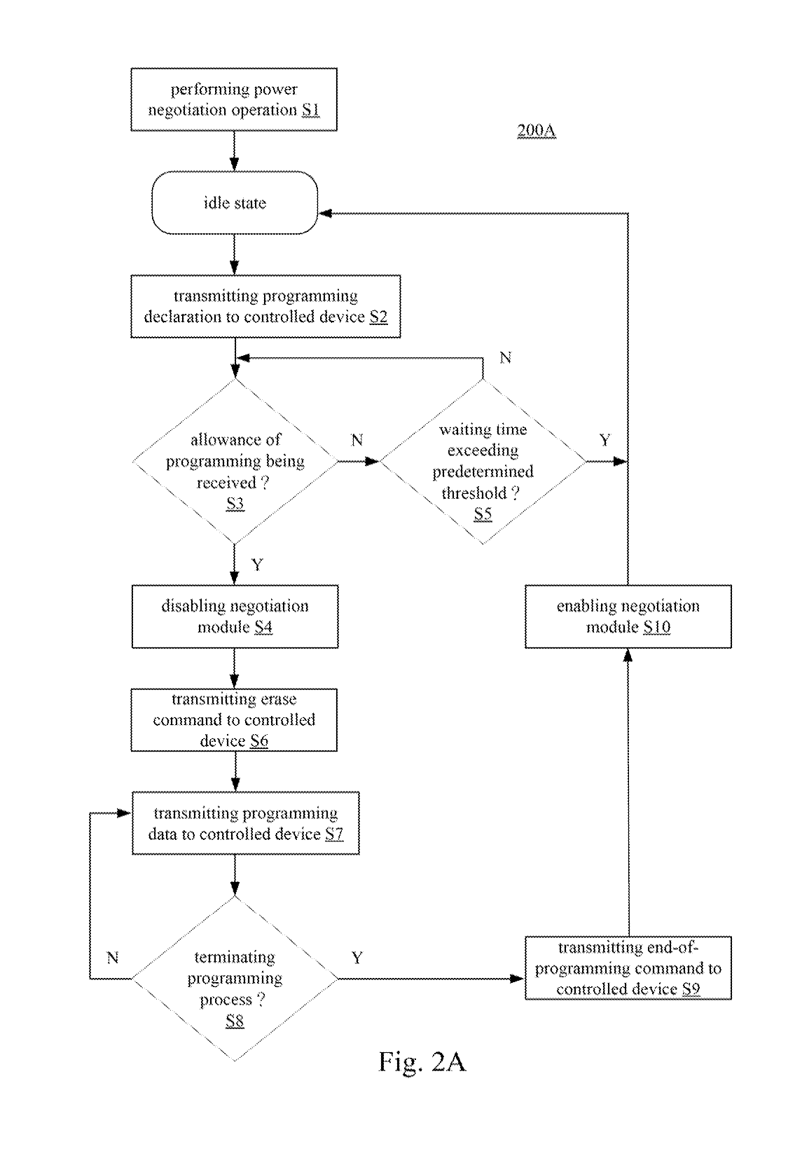

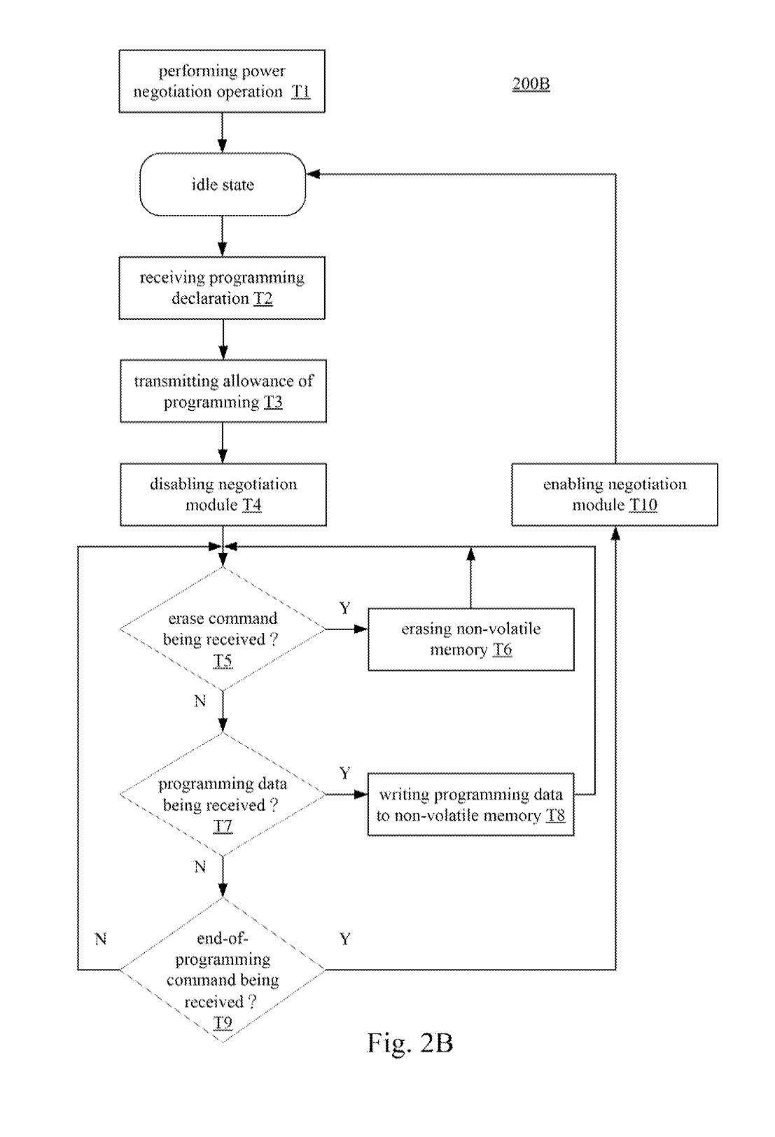

In the following paragraphs, details of the present invention will be described with reference to operating methods of the controlling device and the controlled device shown in the flow charts of FIG. 2A and FIG. 2B. However, the invention is not limited to the embodiments described below.

It is noted that the operating methods can be separately applied to the controlling device and the controlled device having structures that are the same as or similar to the structure shown in FIG. 1. To facilitate the description to follow, in the following paragraphs, the controlling device 110 and the controlled device 120 shown in FIG. 1 will be used as examples to describe the operating method according to one embodiment of the present disclosure. However, the present invention is not limited to such an embodiment.

In addition, it should be noted that, in the steps of the following operating methods, no particular sequence is required unless otherwise specified.

Moreover, the following steps also may be performed simultaneously or the execution times thereof may at least partially overlap.

Furthermore, the steps of the following operating methods may be added, replaced, and/or eliminated as appropriate, in accordance with various embodiments of the present disclosure.

FIG. 2A is a flow chart of an operating method 200A of a controlling device according to one embodiment of the present disclosure. The operating method 200A includes the steps below.

In step S1, the first controller 114 utilizes the first negotiation module 1142 to perform a power negotiation operation with the second negotiation module 1242 of the controlled device 120 via the power pins P1 and P2.

In one embodiment, the power negotiation operation includes determining a power supply direction (e.g., determining whether power is supplied to the controlled device 120 from the controlling device 110, or to the controlling device 110 from the controlled device 120). After the power negotiation operation, one of the first transceiver 112 and the second transceiver 122 can supply the power to the other one of the first transceiver 112 and the second transceiver 122 via the power pins P1 and P2, to allow the consumer to operate based on the received power.

In one embodiment, the first negotiation module 1142 and the second negotiation module 1242 perform the power negotiation operation through, for example, a universal serial bus power delivery (USB-PD) protocol.

In greater detail, according to one embodiment, in the power negotiation operation, the provider (one of the controlling device 110 and the controlled device 120) can provide a source capability message to the consumer (the other of the controlling device 110 and the controlled device 120), in which the source capability message includes a plurality of sets of voltages and currents. In response, the consumer can choose one of the sets of the voltages and the currents based on actual requirements, and transmit a request message corresponding to the chosen set to the provider. Subsequently, the provider can transmit an accept message to the consumer according to the request message, and prepare to provide the voltage and the current of the chosen set requested by the consumer to the consumer according to the request message. After the provider completes the preparation of the voltage and the current requested by the consumer, the provider can provide a PS_RDY message to the consumer.

In step S2, after the power negotiation operation is finished and under a condition that the command provision module 1144 is idle, the first controller 114 utilizes the command provision module 1144 to transmit a programming declaration to the controlled device 120 via the power pins P1 and P2.

In one embodiment, the command provision module 1144 can transmit the programming declaration to the controlled device 120, for example, in response of a specific user command.

In one embodiment, the command provision module 1144 can determine whether the first power pin P1 is occupied by the first negotiation module 1142 (e.g., whether the first negotiation module 1142 is performing the power negotiation operation or confirming the connection state), and subsequently provide the programming declaration to the controlled device 120 via the power pins P1 and P2 during a period when the first power pin P1 is not occupied by the first negotiation module 1142.

In step S3, the first controller 114 utilizes the command provision module 1144 to determine whether an allowance of programming from the controlled device 120 is received. If so, step S4 is executed; if not, step S5 is executed.

In step S4, under a condition that the command provision module 1144 receives the allowance of programming from the controlled device 120, the first controller 114 utilizes the command provision module 1144 to disable the first negotiation module 1142, so as to avoid subsequent operations from being disturbed by communications between the first negotiation module 1142 and the second negotiation module 1242.

In step S5, under a condition that the command provision module 1144 does not receive the allowance of programming from the controlled device 120, the first controller 114 utilizes the command provision module 1144 to determine whether the waiting time for the allowance exceeds a predetermined threshold. If so, the first controller 114 terminates the programming process; if not, the procedure returns to step S3.

In one embodiment, the waiting time described above can be calculated from the programming declaration being transmitted by the command provision module 1144.

In step S6, after the first negotiation module 1142 is disabled, the first controller 114 utilizes the command provision module 1144 to transmit a erase command to the controlled device 120 via the power pins P1 and P2, so as to make the controlled device 120 erase at least a part of the storage space of the non-volatile memory 126.

It is noted that, in some embodiments, step S6 can be omitted as appropriate.

In step S7, after the first negotiation 1142 is disabled, the first controller 114 utilizes the command provision module 1144 to transmit programming data to the controlled device 120 via the power pins P1 and P2, so as to make the controlled device 120 write the programming data into the non-volatile memory 126.

In step S8, the first controller 114 utilizes the command provision module 1144 to determine whether the programming process can be ended (e.g., to determine whether there remains programming data that needs to be transmitted to the controlled device 120). If so, step S9 is executed; if not, the procedure returns to step S7.

In step S9, under a condition that the command provision module 1144 determines the programming process can be ended, the first controller 114 utilizes the command provision module 1144 to transmit an end-of-programming command to the controlled device 120 via the power pins P1 and P2.

In step S10, after the command provision module 1144 transmits the end-of-programming command to the controlled device 120, the first controller 114 utilizes the command provision module 1144 to enable the first negotiation module 1142.

FIG. 2B is a flow chart of an operating method 200B of a controlled device according to one embodiment of the present disclosure. The operating method 200B includes the steps below.

In step T1, the second controller 124 utilizes the second negotiation module 1242 to perform a power negotiation operation with the first negotiation module 1142 of the controlling device 110 via the power pins P1 and P2. Details of the power negotiation operation can be ascertained by referring to the previous paragraphs, and a description in this regard will not be repeated herein.

In step T2, after the power negotiation operation is finished and under a condition that the access module 1244 is idle, the second controller 124 utilizes the access module 1244 to receive a programming declaration from the controlling device 110 via the power pins P1 and P2.

In step T3, the second controller 124 utilizes the access module 1244 to transmit an allowance of programming to the controlling device 110 via the power pins P1 and P2 according to the programming declaration.

In step T4, the second controller 124 utilizes the access module 1244 to disable the second negotiation module 1242 according to the programming declaration, so as to avoid subsequent operations from being disturbed by communications between the first negotiation module 1142 and the second negotiation module 1242.

It is noted that, in some embodiments, the order between step T3 and step T4 can be changed.

In step T5, the second controller 124 utilizes the access module 1244 to determine whether an erase command from the controlling device 110 is received via the power pins P1 and P2. If so, step T6 is executed; if not, step T7 is executed.

In step T6, under a condition that the access module 1244 receives the erase command from the controlling device 110, the second controller 124 utilizes the access module 1244 to erase at least a part of the storage space of the non-volatile memory 126. It is noted that, in some embodiments, step T6 can be omitted as appropriate.

In step T7, under a condition that the access module 1244 does not receive the erase command from the controlling device 110, the second controller 124 utilizes the access module 1244 to determine whether programming data from the controlling device 110 is received via the power pins P1 and P2. If so, step T8 is executed; if not, step T9 is executed.

In step T8, under a condition that the access module 1244 receives the programming data from the controlling device 110, the second controller 124 utilizes the access module 1244 to write the programming data into the non-volatile memory 126.

In one embodiment, the access module 1244 can directly provide the programming data and a corresponding programming command to the non-volatile memory 126 to write the programming data into the non-volatile memory 126. In one embodiment, the access module 1244 can store the programming data into an internal storage component (e.g., a static random-access memory (SRAM)), and write the programming data stored in the internal storage component into the non-volatile memory 126. In one embodiment, the access module 1244 can write the programming data into the non-volatile memory 126 through an intermediary control element (e.g., an embedded controller (EC)) indirectly.

In step T9, under a condition that the access module 1244 does not receive the programming data from the controlling device 110, the second controller 124 utilizes the access module 1244 to determine whether an end-of-programming command from the controlling device 110 is received via the power pins P1 and P2. If so, step T10 is executed; if not, the procedure returns to step T5.

In step T10, under a condition that the access module 1244 receives the end-of-programming command from the controlling device 110, the second controller 124 utilizes the access module 1244 to enable the second negotiation module 1242.

Through the operations describe above, the controlling device 110 can utilize only the power pins P1 and P2 to write the programming data into the non-volatile memory 126 of the controlled device 120 without utilizing data pins. In such a manner, the number of pins of the controlled device 120 and the cost of manufacturing the same can be reduced, and the number of different types of applications for the controlled device 120 can be increased.

In one embodiment, the programming declaration, the allowance of programming, the erase command, the programming data, and the end-of-programming command described above can be transmitted through vender-defined messages (VDMs) defined in a universal serial bus power delivery (USB-PD) protocol. Details in this regard will be specified in the paragraphs below.

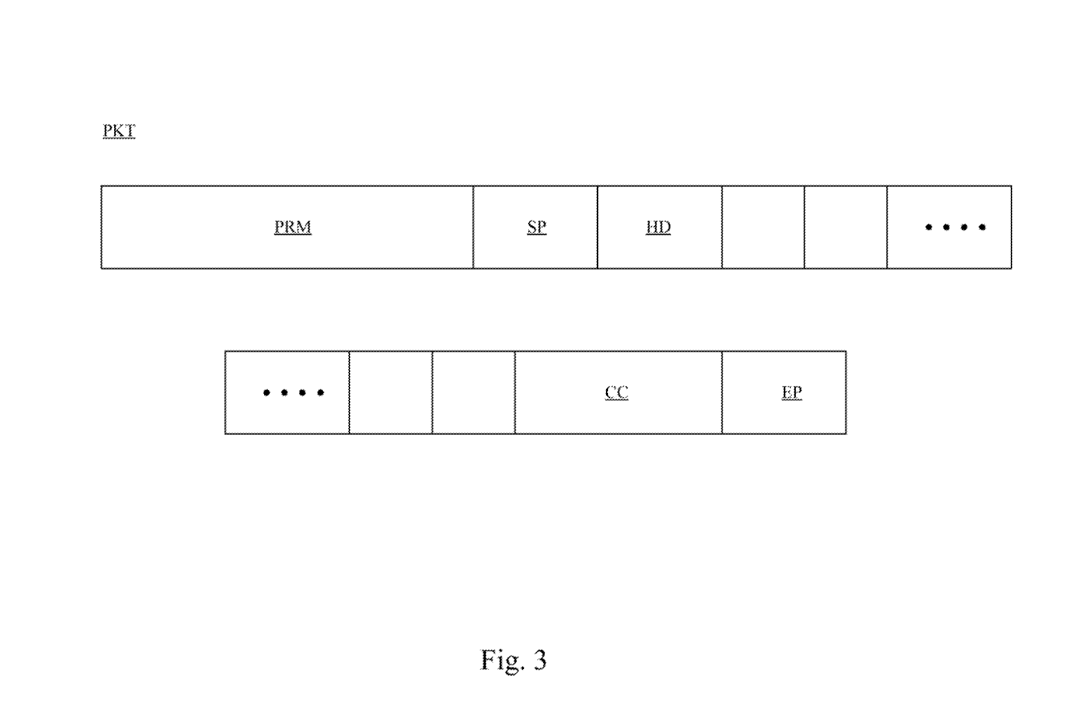

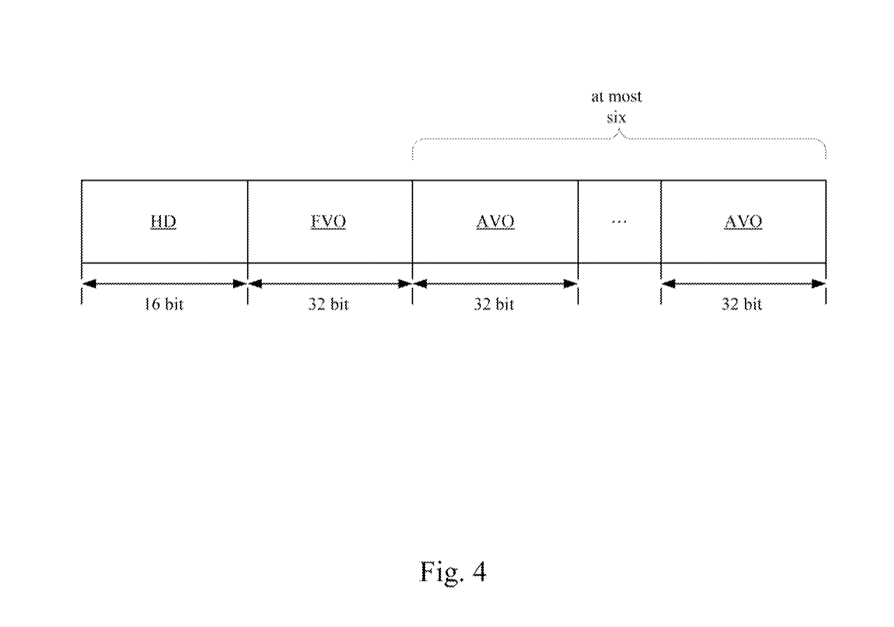

Referring to FIG. 3 and FIG. 4, in one embodiment, a packet PKT transmitted between the controlling device 110 and the controlled device 120 includes a preamble field PRM, a start-of-packet (SOP) field SP, and a packet data field. The packet data field includes a header field HD, a cyclic redundancy check code (CRC code) field CC, and an end-of-packet (EOP) field EP.

In one embodiment, the header field HD can have a length of 16 bits, in which bits 14 to 12 can be used for indicating a quantity of data objects of the packet PKT, and bits 3 to 0 can be used for indicating a packet type of the packet PKT. For example, when bits 3 to 0 in the header field HD are specific values (e.g., “1111”), this packet PKT will be a VDM.

In this embodiment, a VDM can have one to seven data objects, including at least one first VDM object FVO and at most six additional VDM objects AVO. The first VDM object FVO has a length of 32 bits, in which bits 31 to 16 can be used for indicating a vender ID of USB, and bits 15 to 0 can be used for transmitting custom data. Each of the additional VDM objects AVO has a length of 32-bits, and the bits therein can be used for transmitting custom data.

It is noted that the vender ID described above is assigned by the USB implementer forum (USB-IF). A vender can identify the vender-defined commands defined by itself according to the vender ID. Different venders may have different vender IDs.

In this embodiment, each of the VDMs used for transmitting the programming declaration, the allowance of programming, the erase command, and the end-of-programming command described above has one first VDM object FVO and zero addition VDM object AVO. Bits 15 to 0 of the first VDM objects FVO of these VDMs can be used for indicating controlling commands thereof (e.g., indicating that these VDMs are used for transmitting the programming declaration, the allowance of programming, the erase command, and the end-of-programming command).

In addition, a VDM used for transmitting the programming data described above has one first VDM object FVO and at least one addition VDM object AVO. Bits 15 to 0 of the first VDM object FVO of this VDM can be used for indicating a controlling command of the VDM (e.g., indicating that this VDM is used for transmitting programming data). All of the bits of the additional VDM object AVO of this VDM can be used for transmitting the programming data.

For example, in one embodiment, a VDM having a first VDM object with bits 15 to 0 being “0000000000000001” is used for transmitting a programming declaration, and a VDM having a first VDM object FVO with bits 15 to 0 being “0000000000000010” is used for transmitting an allowance of programming. A VDM having a first VDM object FVO with bits 15 to 0 being “0000000000000011” is used for transmitting programming data, and all of the bits of the additional VDM objects AVO of such a VDM are used for carrying the content of the programming data.

In one embodiment, when the controlled device 120 receives a VDM from the controlling device 110, the controlled device 120 may utilize the second controller 124 to identify whether the vender ID (located at bits 31 to 16 of the first VDM object FVO) and/or the controlling command (located at bits 15 to 0 of the first VDM object FVO) is/are correct. If so, the second controller 124 performs the following operation according to the controlling command; if not, the second controller 124 omits this VDM.

In one embodiment, when the controlled device 120 receives a VDM used for transmitting programming data from the controlling device 110, the controlled device 120 may utilize the second controller 124 to store the programming data (located at all of the bits of the additional VDM objects AVO) into an internal storage (e.g., an SRAM), and write the programming data stored in the internal storage into the non-volatile memory 126.

In addition, when the controlled device 120 receives a VDM used for transmitting the programming data from the controlling device 110, the controlled device 120 may utilize the second controller 124 to calculate a cyclic redundancy code, and compare the calculated cyclic redundancy code to the cyclic redundancy code in the cyclic redundancy code field CC of this VDM. If these two are matched, this indicates that the transmission is correct and the controlled device 120 may utilize the second controller 124 to set a correct transmission flag (e.g., to set a flag as 0). If these two do not match, this indicates that the transmission is wrong and the controlled device 120 may utilize the second controller 124 to set a wrong transmission flag (e.g., to set the flag as 1). In one embodiment, the wrong transmission flag will not be eliminated (e.g., the flag be reset as 0) even if the next transmission of a VDM is correct.

In one embodiment, after the programming process is completed, the controlling device 110 may utilize the first controller 114 to transmit a flag-reading command to the controlled device 120 via the power pins P1 and P2. The controlled device 120 may utilize the second controller 124 to transmit the correct transmission flag or the wrong transmission flag to the controlling device 110 via the power pins P1 and P2, so as to allow the user to determine whether to re-execute the programming process according to the correct transmission flag or the wrong transmission flag.

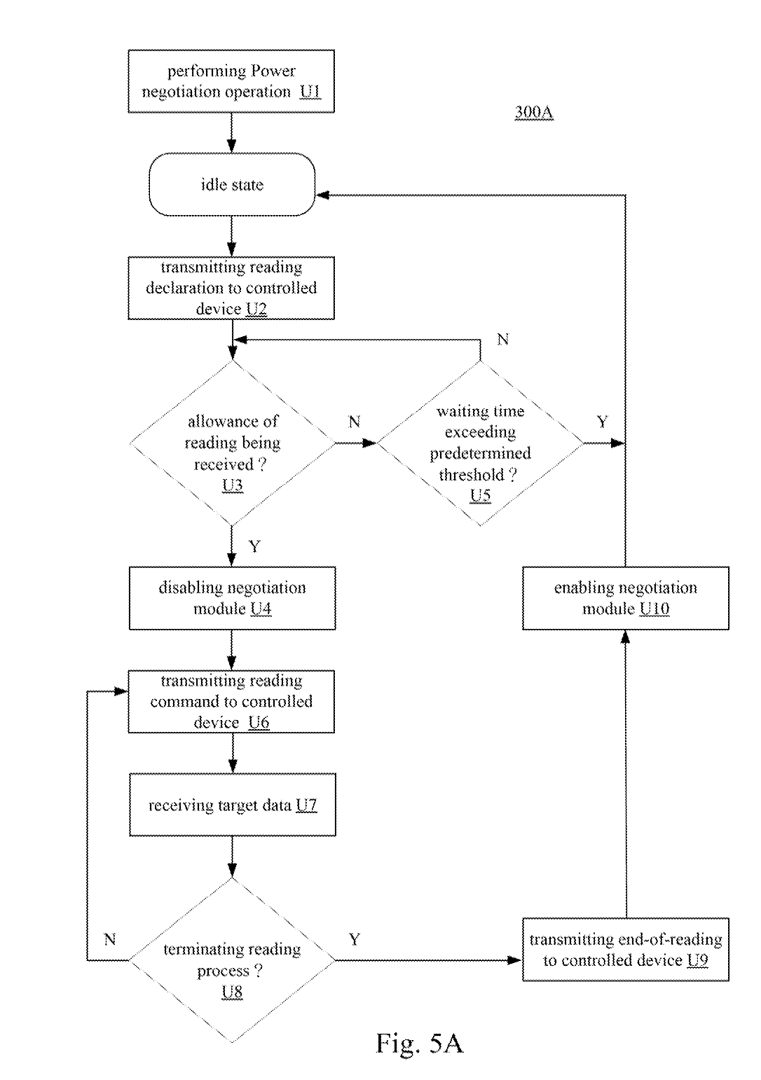

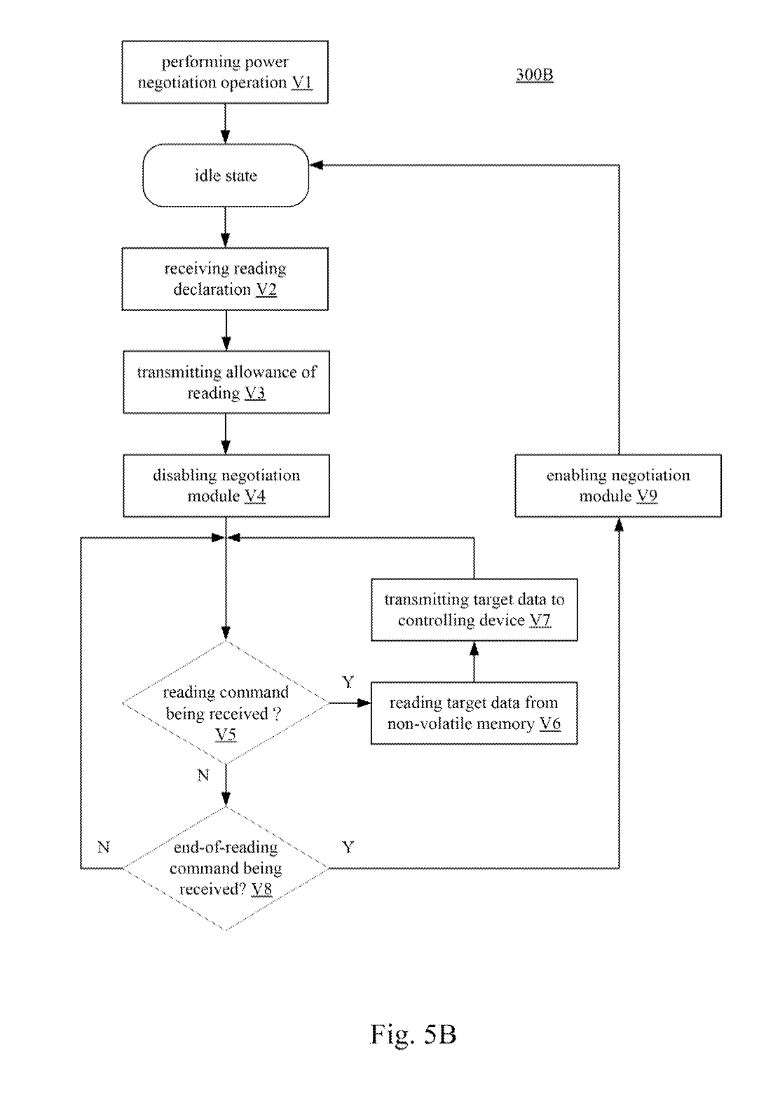

In the following paragraphs, details of the present invention will be described with reference to operating methods of a controlling device and a controlled device in FIG. 5A and FIG. 5B. However, the invention is not limited to the embodiments described below.

It is noted that the operating methods described below can be separately applied to a controlling device and a controlled device having structures that are the same as or similar to the structures shown in FIG. 1. To facilitate the description to follow, in the following paragraphs, the controlling device 110 and the controlled device 120 shown in FIG. 1 will be used as examples to describe the operating method according to one embodiment of the present disclosure. However, the present invention is not limited to the embodiment.

In addition, it should be noted that, in the steps of the following operating methods, no particular sequence is required unless otherwise specified. Moreover, the following steps also may be performed simultaneously or the execution times thereof may at least partially overlap.

Furthermore, the steps of the following operating methods may be added, replaced, and/or eliminated as appropriate, in accordance with various embodiments of the present disclosure.

FIG. 5A is a flow chart of an operating method 300A of a controlling device according to one embodiment of the present disclosure. The operation method 300A includes the steps below.

In step U1, the first controller 114 utilizes the first negotiation module 1142 to perform a power negotiation operation with the second negotiation module 1242 of the controlled device 120 via the power pins P1 and P2. Details of the power negotiation operation can be ascertained by referring to the previous paragraphs, and a description in this regard will not be repeated herein.

In step U2, after the power negotiation operation is finished and under a condition that the command provision module 1144 is idle, the first controller 114 utilizes the command provision module 1144 to transmit a reading declaration to the controlled device 120 via the power pins P1 and P2.

In one embodiment, the command provision module 1144 can transmit the reading declaration to the controlled device 120, for example, in response of a specific user command.

In one embodiment, the command provision module 1144 can determine whether the first power pin P1 is occupied by the first negotiation module 1142 (e.g., whether the first negotiation module 1142 is performing the power negotiation operation or confirming the connection state), and subsequently provide the reading declaration to the controlled device 120 via the power pins P1 and P2 during a period when the first power pin P1 is not occupied by the first negotiation module 1142.

In step U3, the first controller 114 utilizes the command provision module 1144 to determine whether an allowance of reading from the controlled device 120 is received. If so, step U4 is executed; if not, step U5 is executed.

In step U4, under a condition that the command provision module 1144 receives the allowance of reading from the controlled device 120, the first controller 114 utilizes the command provision module 1144 to disable the first negotiation module 1142, so as to avoid subsequent operations from being disturbed by communications between the first negotiation module 1142 and the second negotiation module 1242.

In step U5, under a condition that the command provision module 1144 does not receive the allowance of reading from the controlled device 120, the first controller 114 utilizes the command provision module 1144 to determine whether the waiting time for the allowance exceeds a predetermined threshold. If so, the first controller 114 terminates the reading process and performs control to make the command provision module 1144 return to idle state; if not, the procedure returns to step U3.

In one embodiment, the waiting time described above can be calculated from the programming declaration being transmitted by the command provision module 1144.

In step U6, after the first negotiation module 1142 is disabled, the first controller 114 utilizes the command provision module 1144 to transmit a reading command to the controlled device 120 via the power pins P1 and P2, so as to make the controlled device 120 read a target data from a specific address of the non-volatile memory 126 and make the controlled device 120 return the read target data to the controlling device 110.

In step U7, after the command provision module 1144 transmits the reading command to the controlled device 120, the first controller 114 utilizes the command provision module 1144 to receive the target data from the controlled device 120 via the power pins P1 and P2.

In step U8, the first controller 114 utilizes the command provision module 1144 to determine whether the reading process can be ended (e.g., to determine whether there remains a target date in the nonvolatile memory 126 of the controlled device 120 that needs to be read). If so, step U9 is executed; if not, the procedure returns to step U6.

In step U9, under a condition that the command provision module 1144 determines the reading process can be ended, the first controller 114 utilizes the command provision module 1144 to transmit an end-of-reading command to the controlled device 120 via the power pins P1 and P2.

In step U10, after the command provision module 1144 transmits the end-of-reading command to the controlled device 120, the first controller 114 utilizes the command provision module 1144 to enable the first negotiation module 1142.

FIG. 5B is a flow chart of an operating method 300B of a controlled device according to one embodiment of the present disclosure. The operating method 300B includes the steps below.

In step V1, the second controller 124 utilizes the second negotiation module 1242 to perform a power negotiation operation with the first negotiation module 1142 of the controlling device 110 via the power pins P1 and P2. Details of the power negotiation operation can be ascertained by referring to the previous paragraphs, and a description in this regard will not be repeated herein.

In step V2, after the power negotiation operation is finished and under a condition that the access module 1244 is idle, the second controller 124 utilizes the access module 1244 to receive a reading declaration from the controlling device 110 via the power pins P1 and P2.

In step V3, the second controller 124 utilizes the access module 1244 to transmit an allowance of reading to the controlling device 110 via the power pins P1 and P2 according to the reading declaration.

In step V4, the second controller 124 utilizes the access module 1244 to disable the second negotiation module 1242 according to the reading declaration, so as to avoid subsequent operations from being disturbed by communications between the first negotiation module 1142 and the second negotiation module 1242.

It is noted that, in some embodiments, the order between step V3 and step V4 can be changed.

In step V5, the second controller 124 utilizes the access module 1244 to determine whether a reading command from the controlling device 110 is received via the power pins P1 and P2. If so, step V6 is executed; if not, step V8 is executed.

In step V6, under a condition that the access module 1244 receives the reading command from the controlling device 110, the second controller 124 utilizes the access module 1244 to read a target data from a specific address of the non-volatile memory 126 according to the reading command.

In step V7, after the access module 1244 reads the target data from the specific address of the non-volatile memory 126, the second controller 124 utilizes the access module 1244 to transmit the target data to the controlling device 110 via the power pins P1 and P2. Consequently, the procedure returns to step V5.

In step V8, under a condition that the access module 1244 does not receive the reading command from the controlling device 110, the second controller 124 utilizes the access module 1244 to determine whether an end-of-reading command from the controlling device 110 is received via the power pins P1 and P2. If so, step V9 is executed; if not, the procedure returns to V5.

In step V9, under a condition that the access module 1244 receives the end-of-reading command from the controlling device 110, the second controller 124 utilizes the access module 1244 to enable the second negotiation module 1242.

Through the operations describe above, the controlling device 110 can utilize only the power pins P1 and P2 to read the target data in the non-volatile memory 126 of the controlled device 120 without utilizing data pins. In such a manner, the number of pins of the controlled device 120 and the cost of manufacturing the same can be reduced, and the number of different types of applications for the controlled device 120 can be increased.

It is noted that the reading declaration, allowance of reading, target data, end-of-reading command can be transmitted through VDMs defined in the USB-PD protocol. Details in this regard can be ascertained by referring to the paragraphs described above, and a description in this regard will not be repeated herein.

It is noted that the operating methods 200A and 300A described above may be simultaneously applied to the same controlling device 110 or separately applied to different controlling devices 110. Similarly, the operating methods 200B and 300B described above may be simultaneously applied to the same controlled device 120 or separately applied to different controlled devices 120.

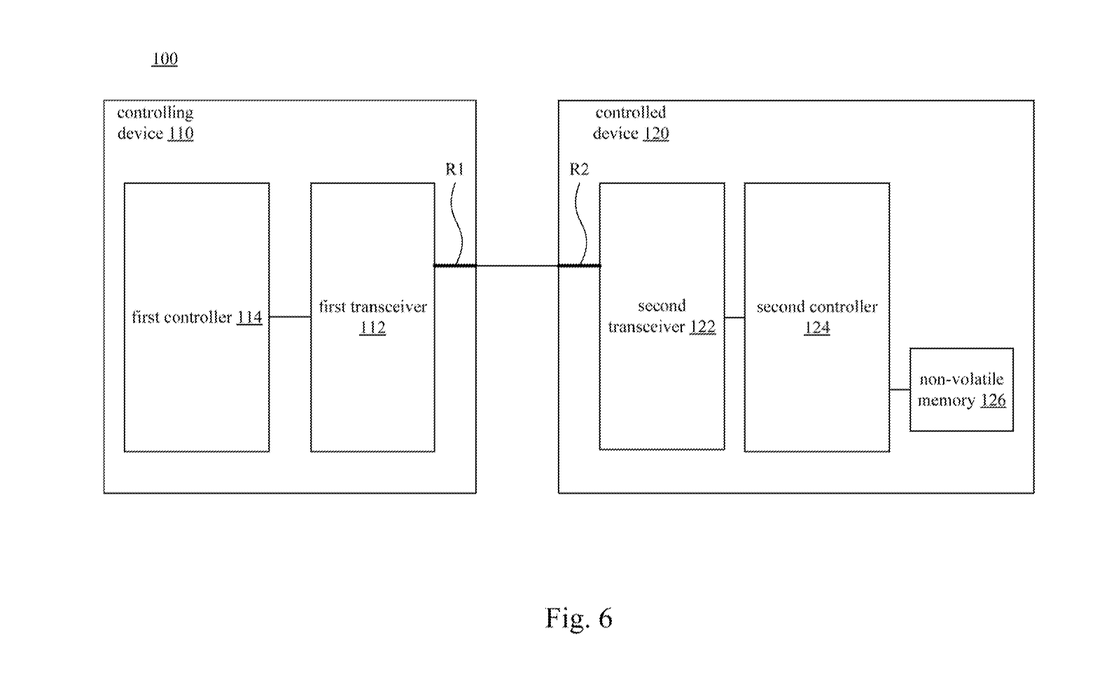

Referring to FIG. 6, in one embodiment, the controlling device 110 can include a configuration channel pin R1 used in a USB Type-C cable and connector. The controlled device 120 can include a configuration channel pin R2 used in the USB Type-C cable and connector. The controlling device 110 and the controlled device 120 can electrically connect to each other via the configuration channel pins R1 and R2.

In this embodiment, the controlling device 110 and the controlled device 120 can determine that the USB connection therebetween is straight or reverse according to the configuration channel pins R1 and R2.

In this embodiment, the controlling device 110 can provide the programming declaration, the erase command, the programming data, the end-of-programming command, the reading declaration, the reading command, and the end-of-reading command described above to the controlled device 120 through VDMs via the configuration channel pins R1 and R2. The controlled device 120 can provide the allowance of programming, the allowance of reading, and the target data described above to the controlling device 110 through VDMs via the configuration channel pins R1 and R2. Thus, through operations similar to the operations described above, the controlling device 110 can utilize only the configuration channel pins R1 and R2 to write the programming data into the non-volatile memory 126 of the controlled device 120 or read the target data in the non-volatile memory 126 without utilizing data pins.

More specifically, in one embodiment, in a programming process, the first controller 114 transmits a programming declaration to the controlled device 120 via the configuration channel pins R1 and R2 (similar to step S2 in FIG. 2A). Subsequently, the first controller 114 determines whether an allowance of programming from the controlled device 120 is received (similar to step S3 in FIG. 2A). If so, the first controller 114 transmits an erase command to the controlled device 120 via the configuration channel pins R1 and R2, so as to make the controlled device 120 erase at least a part of the storage space of the non-volatile memory 126 (similar to step S6 in FIG. 2A); if not, the first controller 114 determines whether the waiting time for the allowance exceeds a predetermined threshold (similar to step S5 in FIG. 2A). If so, the first controller 114 terminates the programming process; if not, the first controller 124 continuously determines whether the allowance of programming from the controlled device 120 is received. After the erase command is transmitted to the controlled device 120, the first controller 114 transmits programming data to the controlled device 120 via the configuration channel pins R1 and R2, so as to make the controlled device 120 write the programming data into the non-volatile memory 126 (similar to step S7 in FIG. 2A). After that, the first controller 114 determines whether the programming process can be ended (similar to step S8 in FIG. 2A). If so, the first controller 114 transmits an end-of-programming command to the controlled device 120 via the configuration channel pins R1 and R2 (similar to step S9 in FIG. 2A); if not, the first controller 114 continuously transmits the programming data to the controlled device 120.

It is noted that the programming process is substantially the same as the operating method 200A in FIG. 2A, and one skilled in the art can utilize the configuration channel pins R1 and R2 to transmit data and commands by referring to the operating method 200A described above. Thus, a description of many aspects that are similar will not be repeated herein.

In addition, in one embodiment, in a programming process, the second controller 124 receives a programming declaration from the controlling device 110 via the configuration channel pins R1 and R2 (similar to step T2 in FIG. 2B). Subsequently, the second controller 124 transmits an allowance of programming to the controlling device 110 via the configuration channel pins R1 and R2 according to the programming declaration (similar to step T3 in FIG. 2B). Subsequently, the second controller 124 determines whether an erase command from the controlling device 110 is received via the configuration channel pins R1 and R2 (similar to step T5 in FIG. 2B). If so, the second controller erases at least a part of the storage space of the non-volatile memory 126 (similar to step T6 in FIG. 2B); if not, the second controller 124 determines whether the programming data from the controlling device 110 is received via the configuration channel pins R1 and R2 (similar to step T7 in FIG. 2B). If so, the second controller 124 writes the programming data into the non-volatile memory 126 (similar to step T8 in FIG. 2B); if not, the second controller 124 determines whether an end-programming command from the controlling device 110 via the configuration pins R1 and R2 is received (similar to step T9 in FIG. 2B). If so, the second controller 124 terminates the programming process; if not, the second controller 124 determines whether the erase command from the controlling device 110 is received via the configuration channel pins R1 and R2 again.

It is noted that the programming process is substantially the same as the operating method 200B in FIG. 2A, and one skilled in the art can utilize the configuration channel pins R1 and R2 to transmit data and commands by referring to the operating method 200B described above. Thus, a description of many aspects that are similar will not be repeated herein.

Furthermore, in one embodiment, in a reading process, the controller 114 transmits a reading declaration to the controlled device 120 via the configuration channel pins R1 and R2 (similar to step U2 in FIG. 5A). Subsequently, the first controller 114 determines whether an allowance of reading from the controlled device 120 is received (similar to step U3 in FIG. 5A). If so, the first controller 114 transmits a reading command to the controlled device 120 via the configuration channel pins R1 and R2, so as to make the controlled device 120 read a target data from a specific address of the non-volatile memory 126 and make the controlled device 120 return the target data to the controlling device 110 (similar to step U6 in FIG. 5A); if not, the first controller 114 determines whether the waiting time for the allowance exceeds a predetermined threshold (similar to step U5 in FIG. 5A). If so, the first controller 114 terminates the reading process; if not, the first controller 114 continuously receives the allowance of reading. After the first controller 114 transmits the reading command to the controlled device 120, the first controller 114 receives the target data from the controlled device 120 via the configuration channel pins R1 and R2 (similar to step U7 in FIG. 5A). After that, the first controller 114 determines whether the reading process can be ended (similar to step U8 in FIG. 5A). If so, the first controller 114 transmits an end-of-reading command to the controlled device 120 via the configuration channel pins R1 and R2 (similar to step U9 in FIG. 5A); if not, the first controller 114 transmits the reading command to the controlled device 120 again.

It is noted that the reading process is substantially the same as the operating method 300A in FIG. 5A, and one skilled in the art can utilize the configuration channel pins R1 and R2 to transmit data and commands by referring to the operating method 300A described above. Thus, a description of many aspects that are similar will not be repeated herein.

Furthermore, in one embodiment, in a reading process, the second controller 124 receives a reading declaration from the controlling device 110 via the configuration channel pins R1 and R2 (similar to step V2 in FIG. 5B). Subsequently, the second controller 124 transmits an allowance of reading to the controlling device 110 via the configuration channel pins R1 and R2 according to the reading declaration (similar to step V3 in FIG. 5B). After that, the second controller 124 determines whether a reading command from the controlling device 110 is received via the configuration channel pins R1 and R2 (similar to step V5 in FIG. 5B). If so, the second controller 124 reads a target data from a specific address of the non-volatile memory 126 according to the reading command (similar to step V6 in FIG. 5B), and subsequently the second controller 124 transmits the target data to the controlling device 110 via the configuration channel pins R1 and R2 (similar to step V7 in FIG. 5B); if not, the second controller 124 determines whether an end-of-reading command from the controlling device 110 is received via the configuration channel pins R1 and R2 (similar to step V8 in FIG. 5B). If so, the second controller 124 ends the reading process; if not, the second controller 124 determines whether the reading command from the controlling device 110 is received via the configuration channel pins R1 and R2 again.

It is noted that the reading process is substantially the same as the operating method 300B in FIG. 5B, and one skilled in the art can utilize the configuration channel pins R1 and R2 to transmit data and commands by referring to the operating method 300B described above. Thus, a description of many aspects that are similar will not be repeated herein.

Although the present disclosure has been described in considerable detail with reference to certain embodiments thereof, other embodiments are possible. Therefore, the scope of the appended claims should not be limited to the description of the embodiments contained herein.

What is claimed is:

1. A controlled device comprising:
a non-volatile memory;
a power pin; and
a controller configured for:
performing, by using a negotiation module, a power negotiation operation with a controlling device via the power pin;
receiving a programming declaration from the controlling device via the power pin;
disabling the negotiation module according to the programming declaration;
receiving a programming data from the controlling device via the power pin after the negotiation module is disabled; and
writing the programming data into the non-volatile memory.

2. The controlled device as claimed in claim 1, wherein the controller performs the power negotiation operation through a universal serial bus power delivery (USB-PD) protocol.

3. The controlled device as claimed in claim 1, wherein the controller receives the programming data through at least one vender-defined message (VDM) defined in the USB-PD protocol.

4. The controlled device as claimed in claim 1, wherein the controller is further configured for:
receiving an end-of-programming command from the controlling device via the power pin; and
enabling the negotiation module according to the end-of-programming command.

5. The controlled device as claimed in claim 1, wherein the controller is further configured for:
receiving an erase command from the controlling device before receiving the programming data, and
erasing the non-volatile memory according to the erase command.

6. The controlled device as claimed in claim 1, wherein the controller is further configured for:
receiving a reading declaration from the controlling device via the power pin;
disabling the negotiation module according to the reading declaration;
receiving a reading command from the controlling device via the power pin after the negotiation module is disabled;
reading a target data in the non-volatile memory according to the reading command; and
transmitting the target data to the controlling device according to the reading command.

7. An operating method applied to a controlled device, the operating method comprising:
performing, by using a negotiation module, a power negotiation operation with a controlling device via the power pin;
receiving a programming declaration from the controlling device via the power pin;
disabling the negotiation module according to the programming declaration;
receiving a programming data from the controlling device via the power pin after the negotiation module is disabled; and
writing the programming data into a non-volatile memory of the controlled device.

8. The operating method as claimed in claim 7, wherein the step of performing the power negotiation operation further comprises:
performing the power negotiation operation through a USB-PD protocol.

9. The operating method as claimed in claim 7, wherein the step of receiving the programming data further comprises:
receiving the programming data through at least one VDM defined in the USB-PD protocol.

10. The operating method as claimed in claim 7 further comprising:
receiving an end-of-programming command from the controlling device via the power pin; and
enabling the negotiation module according to the end-of-programming command.

11. The operating method as claimed in claim 7 further comprising:
receiving an erase command from the controlling device before receiving the programming data, and
erasing the non-volatile memory according to the erase command.

12. The operating method as claimed in claim 7 further comprising:
receiving a reading declaration from the controlling device via the power pin;
disabling the negotiation module according to the reading declaration;
receiving a reading command from the controlling device via the power pin after the negotiation module is disabled;
reading a target data in the non-volatile memory according to the reading command; and
transmitting the target data to the controlling device according to the reading command.

13. A controlling device comprises:
a power pin; and
a controller configured for:
performing, by using a negotiation module, a power negotiation operation with a controlled device via the power pin;
transmitting a programming declaration to the controlled device via the power pin;
receiving an allowance of programming from the controlled device via the power pin after transmitting the programming declaration to the controlled device;
disabling the negotiation module according to the allowance of programming; and
transmitting a programming data to the controlled device via the power pin after the negotiation module is disabled to make the controlled device write the programming data into a non-volatile memory thereof.

14. The controlling device as claimed in claim 13, wherein the controller performs the power negotiation operation through a USB-PD protocol.

15. The controlling device as claimed in claim 13, wherein the controller transmits the programming data through at least one VDM defined in a USB-PD protocol.

16. The controlling device as claimed in claim 13, wherein the controller is further configured for:
determining whether the power pin is occupied by the negotiation module; and
transmitting the programming declaration to the controlled device during a period when the power pin is not occupied by the negotiation module.

17. The controlling device as claimed in claim 13, wherein the controller is further configured for:
transmitting an end-of-programming command to the controlled device via the power pin; and
enabling the negotiation module after transmitting the end-of-programming command to the controlled device.

18. The controlling device as claimed in claim 13, wherein the controller is further configured for:
transmitting an erase command to the controlled device via the power pin before transmitting the programming data to make the controlled device erase the non-volatile memory.

19. The controlling device as claimed in claim 13, wherein the controller is further configured for:
transmitting a reading declaration to the controlled device via the power pin;
receiving an allowance of reading from the controlled device via the power pin after transmitting the reading declaration to the controlled device;
disabling the negotiation module according to the allowance of reading; and
transmitting a reading command to the controlled device via the power pin after the negotiation module is disabled to make the controlled device read a target data stored in the non-volatile memory and retum the target data via the power pin.

20. The controlling device as claimed in claim 19, wherein the controller is further configured for:
transmitting an end-of-reading command to the controlled device; and
enabling the negotiation module after transmitting the end-of-reading command to the controlled device.

21. A controlled device comprises:
a non-volatile memory;
a configuration channel pin; and
a controller configured for:
receiving a programming declaration from a controlling device via the configuration channel pin;
receiving a programming data from the controlling device via the configuration channel pin; and
writing the programming data to the non-volatile memory.

22. The controlled device as claimed in claim 21, wherein the controller receives the programming data through at least one VDM defined in a USB-PD protocol.

23. The controlled device as claimed in claim 21, wherein the controller is further configured for:
receiving an end-of-programming command from the controlling device via the configuration channel pin.

24. The controlled device as claimed in claim 21, wherein the controller is further configured for:
receiving an erase command from the controlling device before receiving the programming data; and
erasing the non-volatile memory according to the erase command.

25. The controlled device as claimed in claim 21, wherein the controller is further configured for:
receiving a reading declaration from the controlling device via the configuration channel pin;
receiving a reading command from the controlling device via the configuration channel pin;
reading a target data in the non-volatile memory according the reading command; and
transmitting the target data to the controlling device according the reading command.
